(19) United States
(12) Patent Application Publication
(10) Pub. No.: US 2013/0288842 A1
(43) Pub. Date: Oct. 31, 2013

(54) CONTINUOUSLY VARIABLE SPEED GEAR SET

(71) Applicants: David Hyung Kim, Seoul (KR); Ki Yong Lee, Gwangju (KR); Kwang Yong Shin, Gwangju (KR)

(72) Inventors: David Hyung Kim, Seoul (KR); Ki Yong Lee, Gwangju (KR); Kwang Yong Shin, Gwangju (KR)

(73) Assignee: KOREA INSTITUTE OF INDUSTRIAL TECHNOLOGY, Cheonan (KR)

(21) Appl. No.: 13/989,788

(22) PCT Filed: Nov. 24, 2011
(86) PCT No.: PCT/KR2011/009007

§ 371 Date: Jun. 13, 2013

(30) Foreign Application Priority Data
Nov. 25, 2010 (KR) 10-2010-0118246

(51) Int. Cl. F16H 3/72

(52) U.S. Cl. CPC F16H 3/725
USPC 475/149

(57) ABSTRACT

There is disclosed a continuously variable speed gear set including a driving input shaft, a carrier extended from one end of the driving input shaft to rotate integrally with the driving input shaft, a spindle gear provided in a predetermined portion of the carrier to relatively rotate with respect to the driving input shaft, the spindle gear comprising a shaft identical to the driving input shaft, a planetary gear arranged in the carrier, a driving output gear comprising a shaft arranged on the same line with the axis of the driving input shaft to relatively rotate, the driving output gear engaging with the planetary gear rotating and revolving along the rotation of the carrier to receive a rotation force from the planetary force, and a transmission input unit configured to control a rotation speed of the driving output gear by controlling a rotation speed of the spindle gear.

### BACKGROUND OF THE DISCLOSURE

1. Field of the Disclosure

The present invention relates to a continuously variable speed gear set, more particularly, to a continuously variable speed gear set that is able to control a rotation speed, only with a simple structure without a multi-gear or a torque converter.

2. Discussion of the Related Art

Generally, an engine for a vehicle or a machine tool for a mechanism includes a driving source and a speed-change (or transmission) device mounted therein to control a final rotation speed of a spindle configured to rotate a shaft of a wheel or a machine tool.

In case of an automobile, such a speed change (or transmission) device can be categorized into a manual transmission manually transmitted by a driver and an automatic transmission automatically transmitted by a computer or a hydraulic mechanism.

Meanwhile, such the transmission includes a set of gears to provide a variety of gear ratios and each gear composing the set of the gears has a different size. The gears engage with each other to provide multi-stepped gear-change operations. The automatic transmission performs gear change by using a torque converter that uses a hydraulic pressure.

However, such a conventional transmission device has following disadvantages.

First, the gradually multi-stepped speed change operations are provided and a gear ratio between each two gears cannot control the multi-stepped speed change (or shift) operations, such that is may be difficult to adjust the gear ratio precisely. Accordingly, a shift shock might be generated by a difference between the gear ratios, when the speed is changed by the gears.

Second, a larger number of gears have to be provided to provide more precise and wider gear ratios. The structure of the transmission device cannot but be complicated and the weight thereof cannot be increase. In addition, a transmission logic might be complex and the production cost might increase accordingly.

Third, eco-friendly products have been standing out and electric vehicles have been under development that are driven by an electric motor instead of an internal combustion engine emitting exhaust gas and carbon dioxide. Although characteristics of such an internal combustion engine are different characteristics of such an electric motor, it is disadvantageous to mount the conventional transmission device in the electric vehicles. Accordingly, there is a growing necessity of developing a new type transmission device.

### SUMMARY OF THE DISCLOSURE

Accordingly, embodiments herewith are directed to a continuously variable speed gear set. An object of the embodiments is to provide a continuously variable speed gear set that is able to continuously vary the gear speed, with a simpler structure.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. To achieve these objects and other advantages and in accordance with the purpose of the invention, as embodied and broadly described herein, a continuously variable speed gear set includes a driving input shaft configured to receive a rotation force of a driving motor; a carrier extended from one end of the driving input shaft to rotate integrally with the driving input shaft; a spindle gear provided in a predetermined portion of the carrier to relatively rotate with respect to the driving input shaft, the spindle gear comprising a shaft identical to the driving input shaft; a planetary gear arranged in the carrier to revolute around the driving input shaft along the rotation of the carrier, and engaging with the spindle gear to rotate on its axis while revolving around the carrier along the rotation of the carrier; a driving output gear comprising a shaft arranged on the same line with the axis of the driving input shaft to relatively rotate, the driving output gear engaging with the planetary gear rotating and revolving along the rotation of the carrier to receive a rotation force from the planetary force; and a transmission input unit configured to control a rotation speed of the driving output gear by controlling a rotation speed of the spindle gear.

The transmission input unit may include a warm gear engaging with the spindle gear to rotate the spindle gear; a transmission motor configured to rotate the warm gear; a control module configured to control a rotation speed of the transmission motor.

The spindle gear may include a first tooth form formed in a circumferential portion of the spindle gear to engage with the warm gear along the rotation of the warm gear; and a second tooth form formed in a circumferential portion of the spindle gear toward a planetary gear of the first tooth form, to engage with the planetary gear to rotate together with the first tooth form.

The planetary gear may include a shaft rotatable with respect to the carrier, spaced apart a predetermined distance from a shaft of the carrier; a third tooth form provided adjacent to the spindle gear of the shaft to engage with the spindle gear; and a fourth tooth form provided in opposite to the spindle gear of the shaft to engage with the driving output gear while rotating along the rotation of the third tooth form.

The driving output gear may include a fifth tooth form configured to engage with the planetary gear to receive a rotation force of the planetary gear.

The transmission input unit may control a transmission motor in a direction where the rotation speed of the driving output gear is decreased by the driving motor.

The transmission input unit may control the transmission motor to make a rotation direction of the spindle gear the reverse direction of the rotation direction of carrier.

According to the present invention, there are following advantageous effects. Without using the conventional torque converter, the continuously variable speed gear set according to the embodiments can is continuously perform speed variation, in other words, transmission, with a simple structure. Accordingly, ride comfort can be improved and the continuously speed variation gear set according to the embodiments can be controlled by a gear ratio that demonstrates optimized efficiency. When it is applied to an electric vehicle, the continuously speed variable can achieve optimized efficiency effectively.

Furthermore, the spindle gear is rotated by the warm gear and the warm gear is not rotated by the rotation force of the spindle gear according to structural characteristics of the warm gear. The transmission motor may rotate the warm gear to make a rotation direction of the spindle gear the reverse direction of the rotation direction of the carrier. Accordingly, the driving force of the transmission motor need not be large and a lower-priced transmission motor can be applied. product reliability can be enhanced and the production cost can be lowered effectively.

Still further, the continuously variable speed gear set may have a simple structure and it is small-sized. Also, the weight of the gear set can be reduced and design freedom can be effectively improved.

Still further, in case the tooth form of the idle gear or driving gear is a conical gear, a bevel gear or a spiral gear, it is not necessary for a shaft of the idle or driving gear to be parallel or orthogonal. Accordingly, design freedom can be enhanced effectively.

It is to be understood that both the foregoing general description and the following detailed description of the embodiments are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram schematically illustrating a driving system of an electric vehicle that includes a continuously variable speed gear set according to embodiments;

FIG. 2 is a sectional diagram illustrating a continuously variable speed gear set according to one embodiment;

FIG. 3 is a perspective diagram illustrating the continuously variable speed gear set of FIG. 2; and

FIG. 4 is a perspective diagram illustrating the continuously variable speed gear set of FIG. 3, seen at a different angle.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts. Before describing embodiments, it is exemplified that a continuously variable speed gear set according to embodiments is applied to an electric vehicle and the embodiments herewith are not limited thereto. The continuously variable speed gear set according to the embodiments can be applied to a conventional vehicle that uses a conventional internal combustion engine as a power and it also can be applied to any devices configured to vary the speeds, while transmitting a rotational speed and a rotation force of the power, that can be applied to the conventional vehicles and machine tools.

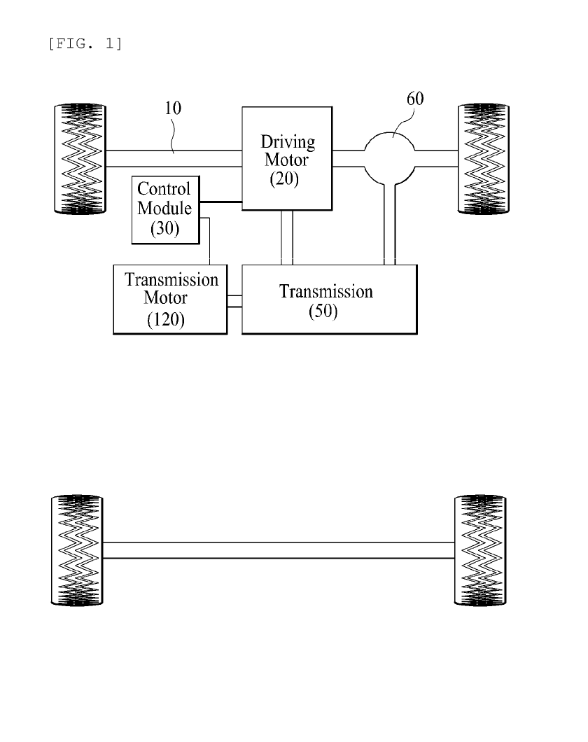

As shown in FIG. 1, such the electric vehicle includes a driving motor 20, a battery (not shown) and a control module 30 configured to control a rotation speed of the driving motor 20.

Furthermore, the electric vehicle includes a transmission 50 configured to vary the rotation force and the rotation speed, while transmitting a driving force of the driving motor 20 to a shaft 10. the transmission 50 is coupled to a differential gear 60 provided in the shaft 10 for front wheels or rear wheels and it transmits the driving force.

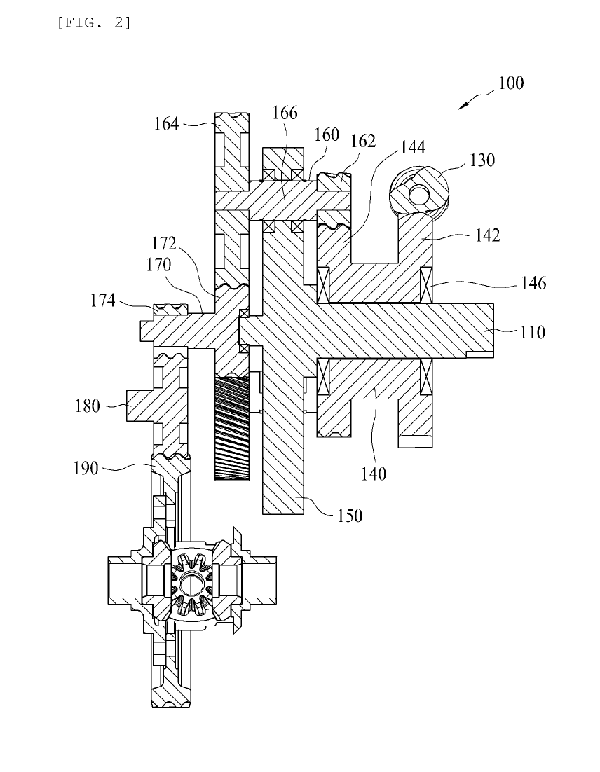

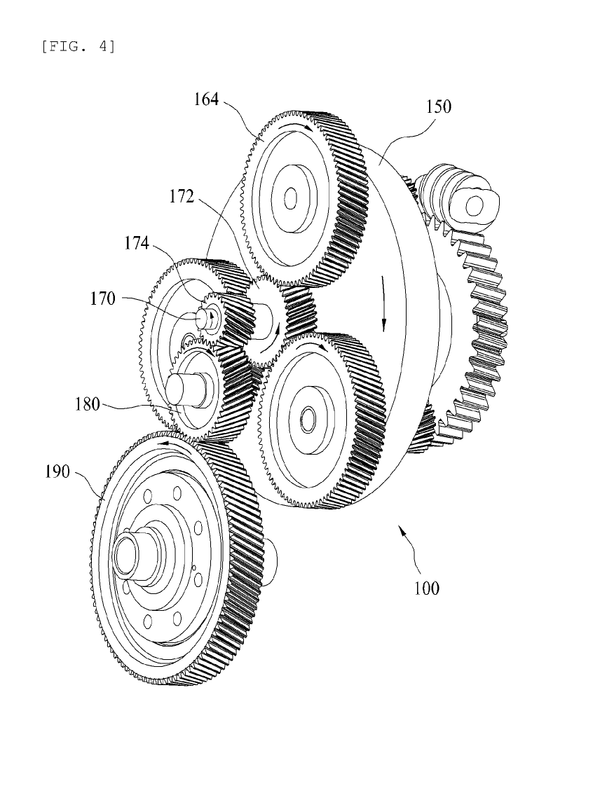

Meanwhile, in the transmission 50 mentioned above may be provided a continuously variable speed gear set 100 configured to vary the rotational speed and the rotation force transmitted from the driving motor, as shown in FIGS. 2 to 4.

The continuously variable speed gear set 100 may include a driving input shaft 110, a carrier 150, a spindle gear 140, a planetary gear 160 and a driving output gear 170 and a transmission input unit.

The driving input shaft 110 is a shaft that is rotatable via a rotation force transmitted from the driving motor 20.

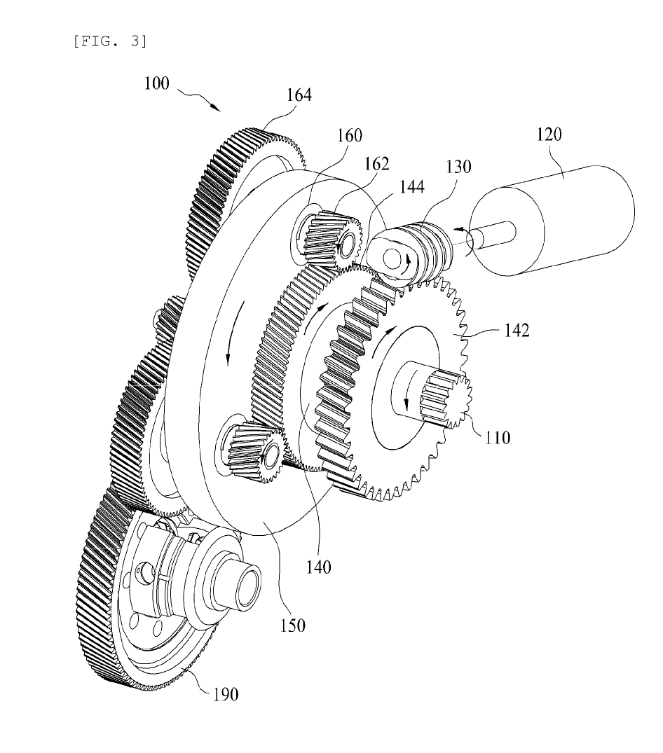

As shown in FIGS. 2 and 3, the carrier 150 may be extended from the driving input shaft 110 in a direction of a diameter of the driving input shaft 110, to integrally rotate with the driving input shaft 110. the carrier 150 may be formed in a circular flange shape or a bar shape extended along a diameter direction of the driving input shaft 110. The shape of the carrier 150 is not limited thereto.

The spindle gear 140 has a central portion rotatably coupled to the driving input shaft 110, in a state of being rotatably supported by a bearing 146. The spindle gear 140 has a rotational axis that is identical to a rotational axis of the driving input shaft 110.

Accordingly, the spindle gear 140 may be rotatable on the driving input shaft 110 as its axis, independent from the driving input shaft 110.

The planetary gear 160 is rotatably provided in a state of spaced apart a predetermined distance from the rotational axis of the carrier 150 rotated integrally with the driving input shaft 110. The planetary gear 160 may revolve around the driving input shaft 110 along the rotation of the carrier 150. In addition, the planetary gear 160 engages with the spindle gear 140 and revolves around the carrier 150 along the rotation of the carrier 150, simultaneously while rotating on its axis by engaging with the spindle gear 140.

The driving output gear 170 is arranged on the same line with the axis of the driving input shaft 110 and it is supported by a bearing to relatively rotate with respect to the driving input shaft 110. The driving output gear 170 engages with the planetary gear 160 and it is rotated by a rotation force transmitted from the rotation of the planetary gear 160.

At this time, when the planetary gear 160 engages with the spindle gear 140 to revolve around the rotation of the carrier 150 and simultaneously engages with the spindle gear 140 to rotate on its axis, such that a rotation speed and a rotation force generated by the combination of the rotation force generated by the revolution of the planetary gear 160 and the rotation force generated by the rotation of the planetary gear 160 may be transmitted to the driving output gear 170 to rotate the driving output gear 170.

Moreover, the driving output gear 170 may engage with a idle gear 180 and a driving gear 190, to transmit a driving force to the driving shaft 10.

A transmission input unit may be provided to control the rotation speed of the planetary gear 160 to control the rotational speed of the driving output gear 170.

Each of the components provided in the continuously variable speed gear set will be described in detail as follows.

The transmission input unit may include a transmission motor 120 configured to be driven independently with respect to the driving motor 20, having a rotation speed controllable by the control module 30, a warm gear 130 rotated by the transmission motor 120 and the spindle gear 140.

The spindle gear 140 is rotatably coupled to the driving input shaft 110 by a bearing 146. The spindle gear 140 includes a first tooth form 142 formed in an outer circumferential portion thereof and engaging with the warm gear 130 to rotate along the rotation of the warm gear 130 and a second tooth form 144 spaced apart a predetermined distance from the first tooth form 142 in a radial direction.

The first tooth form 142 and the second tooth form 144 are integrally formed with each other as one body, such that the second tooth form 144 also may rotate together with the first tooth form 142 rotated by the warm gear 130.

Meanwhile, the planetary gear 160 may include a rotation shaft 166 rotatable with respect to the carrier 150, passing through the carrier 150, a third tooth form 162 provided toward the spindle gear 140 of the rotation shaft 166 to engage with the second tooth form 144 of the spindle gear 140, and a fourth tooth form 164 provided in an end opposite to the spindle gear 140 of the rotation shaft 166 to be rotatable integrally with the third tooth form 162.

One planetary gear 160 may be provided in the carrier 150 or a plurality of planetary gears 160 may be provided.

Accordingly, the planetary gear 160 is rotated on its axis by engaging with the spindle gear 140, while being revolved around the driving input shaft 110 by the rotation of the carrier 150, such that the rotation speed of the planetary gear 160 may be getting fast or slow according to the rotation of the spindle gear 140.

Alternatively, the spindle gear 140 may not divided into the first tooth form 142 and the second tooth form 144 and it may include one tooth form. In this instance, the third tooth form 162 of the planetary gear 160 and the warm gear 130 may engage with the single tooth form formed in the spindle gear 140 together. Or, the first tooth form 142 and the second tooth form 144 may be formed continuously, not spaced apart from each other.

As mentioned above, the driving output gear 170 includes a fifth tooth form 172 formed therein to engage with the fourth tooth form 164 of the planetary gear 160, such that it may be rotated by the revolution and the rotation of the fourth tooth form 164. At this time, the fourth tooth form 164 may be integrally rotated with the third tooth form 162. The rotation speed of the third tooth form 162 is determined based on the combination between the rotation speed generated by the driving input shaft 110 and the rotation number generated by the rotation of the spindle gear 140. The fourth tooth form 164 is integrally rotated with the third tooth form 162, such that the rotation speed of the driving output gear 170 may be determined based on the combination between the rotation speed generated by the driving input shaft 110 and the rotation speed generated by the rotation of the spindle gear 140 and the gear ratios of the warm gear 130 and the first tooth form 142, the second tooth form 144, the third tooth form 162, the fourth tooth form 164 and the fifth tooth form 172.

In addition, a sixth tooth form 174 rotated together with the fifth tooth form 172 is formed in an outer portion of the driving output gear 170. The sixth tooth form 174 engages with an idle gear 180 and the like, to transmit a driving force to the driving gear 190 configured to transmit a driving force to the driving shaft 10. The driving gear 190 is coupled to a differential gear 60 of the shaft 10 to rotate the shaft 10. Although not shown in the drawings, another gear or a power transfer shaft may be provided between the driving output gear 170 and the driving gear 190.

The sixth tooth form 174, the idle gear 180 and the driving gear 190 may be not only a spur gear but also a conical gear, a bevel gear or a spiral gear, if necessary. Accordingly, the axis of the sixth tooth form 174 and axes of the driving gear 190 and the driving gear 190 may not be parallel or perpendicular necessarily but be designed freely.

The rotation number and force of the driving output gear 170 may be adjusted according to the rotation speed and force input from the driving input shaft 110, the gear ratios of the tooth forms and the rotation speed of the spindle gear 140.

Here, the ratios of the tooth forms are fixed. If the output power of the driving motor 20 is uniform, the rotation speed and force of the driving output gear 170 can be controlled according to the rotation speed of the spindle gear 140.

The control module 30 may control the rotation speed of the driving motor 20 and simultaneously controls the transmission motor 120 to transmit the proper rotation speed and the proper rotation force to the shaft 10 according to the present situation of the electric car.

As mentioned above, the transmission motor 120 rotates the warm gear 130 and the warm gear 130 rotates the spindle gear engaging therewith.

At this time, the warm gear 130 may be driven to rotate the spindle gear 140 in the reverse direction with respect to the rotation of the carrier 150.

Accordingly, the rotation speed of the planetary gear 160 engaging with the second tooth form 144 of the spindle gear 140 is getting as slow as the rotation speed of the spindle gear 140, such that the rotation speed of the driving output gear 170 may be decreased.

The rotation speed is in reverse proportion to the rotation force (the torque) such that the torque of the driving output shaft may be increased.

In other words, on the assumption that the rotation speed and the rotation force (torque) of the driving motor 20 is uniform, the rotation speed transmitted to the driving

Accordingly, the control module 30 controls the transmission motor 120 to form a reduction gear ratio that demonstrates an optimized speed and an optimized torque according to the present speed and the load of the electric vehicle. In the control module 30 may be stored data or transmission patterns on an optimized reduction gear ratio according to the optimized rotation speed of the driving motor 20 that is proper to the present situation of the electric vehicle.

At this instance, the rotation speed of the warm gear 130 is variable continuously and the rotation speed of the driving output gear 170 is also variable continuously, not multi-staged.

At this time, the spindle gear 140 is rotated by the torque of the warm gear 130 transmitted thereto according to structural characteristics. In contrast, the rotation force transmitted in the reverse direction, in other words, the torque of the spindle gear may not be transmitted as the torque of the warm gear 130.

Moreover, the rotation force of the spindle gear 140 is not transmitted to the warm gear 130. The spindle gear 140 is rotated in a direction of lowering the rotation speed of the planetary gear 160, not a direction of heightening the rotation speed, such that a motor having a lower power than the driving motor 20 may be used as the transmission motor 120 configured to drive the warm gear 130.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A continuously variable speed gear set comprising:
a driving input shaft configured to receive a rotation force of a driving motor;
a carrier extended from one end of the driving input shaft to rotate integrally with the driving input shaft;
a spindle gear provided in a predetermined portion of the carrier to relatively rotate with respect to the driving input shaft, the spindle gear comprising a shaft identical to the driving input shaft;
a planetary gear arranged in the carrier to revolute around the driving input shaft along the rotation of the carrier, and engaging with the spindle gear to rotate on its axis while revolving around the carrier along the rotation of the carrier;
a driving output gear comprising a shaft arranged on the same line with the axis of the driving input shaft to relatively rotate, the driving output gear engaging with the planetary gear rotating and revolving along the rotation of the carrier to receive a rotation force from the planetary force; and
a transmission input unit configured to control a rotation speed of the driving output gear by controlling a rotation speed of the spindle gear.

2. The continuously variable speed gear set according to claim 1, wherein the transmission input unit comprises,
a warm gear engaging with the spindle gear to rotate the spindle gear;
a transmission motor configured to rotate the warm gear;
a control module configured to control a rotation speed of the transmission motor.

3. The continuously variable speed gear set according to claim 2, wherein the spindle gear comprises,
a first tooth form formed in a circumferential portion of the spindle gear to engage with the warm gear along the rotation of the warm gear; and
a second tooth form formed in a circumferential portion of the spindle gear toward a planetary gear of the first tooth form, to engage with the planetary gear to rotate together with the first tooth form.

4. The continuously variable speed gear set according to claim 1, wherein the planetary gear comprises,
a shaft rotatable with respect to the carrier, spaced apart a predetermined distance from a shaft of the carrier;
a third tooth form provided adjacent to the spindle gear of the shaft to engage with the spindle gear; and
a fourth tooth form provided in opposite to the spindle gear of the shaft to engage with the driving output gear while rotating along the rotation of the third tooth form.

5. The continuously variable speed gear set according to claim 1, wherein the driving output gear comprises,
a fifth tooth form configured to engage with the planetary gear to receive a rotation force of the planetary gear.

6. The continuously variable speed gear set according to claim 2, wherein the transmission input unit controls a transmission motor in a direction where the rotation speed of the driving output gear is decreased by the driving motor.

7. The continuously variable speed gear set according to claim 6, wherein the transmission input unit controls the transmission motor to make a rotation direction of the spindle gear the reverse direction of the rotation direction of carrier.
